(19) United States
(12) Patent Application Publication
(10) Pub. No.: US 2026/0294712 A1
(43) Pub. Date: Oct. 1, 2026

(54) USER INTERFACE FOR CONTROLLING A TURN BLADDER FOR A SUPPORT SURFACE

(71) Applicant: Stryker Corporation, Portage, MI (US)

(72) Inventors: Anna Lorino, Portage, MI (US); Alexis Czopek, Portage, MI (US); Brianna R. Graves, Paw Paw, MI (US); Marco Constant, Portage, MI (US); Nicholas D. Koch, Battle Creek, MI (US); Caleb D. Gossens, Ravenna, MI (US); Minakshi Seth, Portage, MI (US); Andrew Weiandt, Portage, MI (US)

(21) Appl. No.: 19/633,167

(22) Filed: Mar. 30, 2026

Related U.S. Application Data
(60) Provisional application No. 63/780,932, filed on Mar. 31, 2025.

(51) Int. Cl. A61G 7/057; A61G 7/00

(52) U.S. Cl. CPC A61G 7/05769; A61G 7/001; A61G 2203/20; A61G 2203/34

(57) ABSTRACT

A patient support system is provided and includes a control system capable of directing inflation of an inflatable bladder (e.g., a turning bladder) according to a preset input (or a coarse input selection) and directing an adjustment to the inflation according to a user input, such as a fine adjustment.

### TECHNICAL FIELD

The present disclosure relates to mattresses used for supporting individuals thereon, and more particularly to a user interface and/or a control methodology for mattresses that are used in healthcare settings and that have one or more inflatable zones.

### BACKGROUND

In health care settings, mattresses are used to support patients positioned on beds, stretchers, cots, and the like. In many instances, such mattresses include one or more inflatable bladders whose inflation levels can be controlled. In order to reduce the likelihood of the patient developing bed sores, or aggravating pre-existing bed sores, the inflation level of the bladders should be set so as to distribute the patient's weight over as great an area as possible, or over an area large enough to reduce undesired force concentrations on the patient's body. Additionally, one or more of the inflatable bladders may be configured to assist in turning a patient toward a left side or a right side.

Conventional mattresses having bladders for assisting in turning a patient often are in fluid communication with a compressor capable of pressurizing an inflatable bladder with fluid. Conventional controls over supply of fluid to and from the inflatable bladder often provide preset control options for pressuring the inflatable bladders to assist in a turn. These preset options often limit the caregiver's ability to effectively turn the patient.

### SUMMARY OF THE DESCRIPTION

In general, one innovative aspect of the subject matter described herein can be embodied in a patient support system for a patient support apparatus including a deck with one or more deck sections. The patient support system may include a patient support being supported on the deck. The patient support system may include an inflatable bladder operable to facilitate turning a patient disposed on the patient support. The patient support system may include a fluid source operable to supply fluid under pressure to the inflatable bladder. The patient support system may include a control system configured to direct inflation of the inflatable bladder. The control system may be operable to deflate the inflatable bladder and to direct inflation of the inflatable bladder toward a target inflation value according to one of a plurality of presets.

The control system may be operable, while directing inflation toward the target inflation value, to direct an adjustment in the target inflation value of the inflatable bladder based on input from a caregiver.

The foregoing and other aspects can each optionally include one or more of the following features, alone or in combination. In particular, one aspect includes all the following features in combination.

In one aspect, in response to the input from the caregiver, the control system may adjust the target inflation value to a current inflation value of the inflatable bladder so that the control system ceases inflating the inflatable bladder toward a prior target inflation value associated with the one or more presets.

In one aspect, in response to the input from the caregiver, the control system may pause inflation, and where a hold timer starts so that the inflatable bladder may be scheduled to remain at the current inflation value for a duration corresponding to a hold time.

In one aspect, in response to user selection of a new preset other than an initially selected preset of the one or more presets and before a current inflation value of the inflatable bladder reaches the target inflation value, the control system may adjust the target inflation value to correspond to the new preset.

In one aspect, if the new preset is below the initially selected preset, the control system may deflate the inflatable bladder by exhausting fluid until the current inflation value corresponds to the target inflation value associated with the new preset, and where, after the current inflation value corresponds to the target inflation value, the control system may initiate a hold timer for a duration corresponding to a hold duration input to the control system.

In one aspect, the adjustment in the target inflation value of the inflatable bladder may be initiated during inflation of the inflatable bladder according to the one or more presets.

In one aspect, the patient support system may include a user interface operable to receive user input from the caregiver. The user interface may be communicatively coupled to the control system and operably provide the user input to the control system.

In one aspect, the user interface may include a graphical depiction of the patient support, and where the graphical depiction may be animated to depict a change in level of the patient support in response to selection of the user input from the caregiver.

In one aspect, the user interface may include a graphical representation of a patient disposed on the patient support, and where, when the inflatable bladder is inflated, the graphical representation of the patient shows at least a portion of the patient visually separated from a surface of the patient support.

In one aspect, the user interface may include one or more preset inputs corresponding respectively to the one or more presets, and where the user interface may include a first adjustment input respectively corresponding to the input on which the adjustment in the target inflation value of the inflatable bladder is based.

In one aspect, the first adjustment input may correspond to an upward adjustment input that directs the control system to increase the target inflation value relative to a current target inflation value.

In one aspect, the user interface may include a second adjustment input that directs the control system to decrease the target inflation value relative to the current target inflation value.

In one aspect, the user interface may include a status indicator that provides an indication of a current inflation value of the inflatable bladder.

In one aspect, the inflatable bladder may be a first turning bladder, and the system may include a second turning bladder operable to facilitate turning the patient disposed on the patient support. The control system may be operable to direct inflation and deflation of the second turning bladder toward a second target inflation value according to the one or more presets.

In one aspect, the patient support system may include a selectable valve operable to selectively direct fluid from the fluid source to the inflatable bladder.

In one aspect, the fluid source may be external to the patient support.

In one aspect, the fluid source may be a compressor.

In one aspect, the patient support system may include a sensor system operable to generate sensor output indicative of a fluid pressure of the inflatable bladder, where a current inflation value of the inflatable bladder may be based on the sensor output.

In one aspect, the control system may be configured to store the target inflation value corresponding to the selected preset, a selected duration, and a selected bladder as default settings, where the user interface may indicate the default settings as being selected for a subsequent turning operation, such that the caregiver may be capable of initiating the subsequent turning operation according to the default settings without re-selection of the default settings.

In one aspect, the caregiver may be capable of modifying the default settings for the subsequent turning operation.

In general, one innovative aspect of the subject matter described herein can be embodied in a patient support system for a patient support apparatus including a deck with one or more deck sections, and a patient support being supported on the deck. The patient support system may include a pressure sensor interface operable to receive sensor information indicative of a fluid pressure of an inflatable bladder associated with the patient support. The patient support system may include a fluid control interface operably coupled to a fluid mover and configured to direct the fluid mover to supply fluid under pressure to the inflatable bladder. The patient support system may include a user interface operable to receive a first user input from a caregiver corresponding to a selected level from among a plurality of levels. The user interface may be operable to receive a second user input from the caregiver corresponding to an adjustment in inflation of the inflatable bladder. The patient support system may include a controller operably coupled to the pressure sensor interface and the fluid control interface. The controller may be configured to determine a target inflation value based on the selected level from among the plurality of levels. The controller may be configured to direct operation of the fluid mover, via the fluid control interface, to change an inflation level of the inflatable bladder based on the target inflation value and a current inflation value. The controller may be configured to direct the adjustment in the target inflation value based on the second user input from the caregiver, where the current inflation value may be based on the sensor information.

The foregoing and other aspects can each optionally include one or more of the following features, alone or in combination. In particular, one aspect includes all the following features in combination.

In one aspect, in response to the second user input from the caregiver, the controller may adjust the target inflation value to the current inflation value of the inflatable bladder so that the controller ceases inflating the inflatable bladder toward a prior target inflation value associated with the plurality of levels.

In one aspect, in response to the second user input from the caregiver, the control system may pause inflation, and where a hold timer starts so that the inflatable bladder is scheduled to remain at the current inflation value for a duration corresponding to the hold time.

In one aspect, in response to user selection of a new level other than an initially selected level of the plurality of levels and before a current inflation value of the inflatable bladder reaches the target inflation value, the control system may adjust the target inflation value to correspond to the new level.

In one aspect, if the new level is below the initially selected level, the control system may deflate the inflatable bladder by exhausting fluid until the current inflation value corresponds to the target inflation value associated with the new level, and where, after the current inflation value corresponds to the target inflation value, the control system may initiate a hold timer for a duration corresponding to a hold duration input to the control system.

In one aspect, the adjustment in the target inflation value of the inflatable bladder may be initiated during inflation of the inflatable bladder according to the one or more levels.

In one aspect, the user interface may include one or more preset inputs corresponding respectively to the one or more levels.

In one aspect, the second user input may correspond to an upward adjustment input that directs the controller to increase the target inflation value relative to a current target inflation value.

In one aspect, the user interface may include a second adjustment input that directs the controller to decrease the target inflation value relative to the current target inflation value.

In one aspect, the user interface may include a status indicator that provides an indication of the current inflation value of the inflatable bladder.

In one aspect, the inflatable bladder may include a first turning bladder, and the patient support system may include a second turning bladder operable to facilitate turning a patient disposed on the patient support. The controller may be operable to direct inflation and deflation of the second turning bladder toward a second target inflation value according to the one or more levels.

In one aspect, the patient support system may include a selectable valve operable to selectively direct fluid from the fluid mover to the inflatable bladder.

In one aspect, the user interface may include a graphical representation of a patient disposed on the patient support, and wherein, when the inflatable bladder is inflated, the graphical representation of the patient shows at least a portion of the patient visually separated from a surface of the patient support.

In one aspect, the controller may be configured to store the target inflation value corresponding to the selected level, a selected duration, and a selected bladder as default settings, where the user interface may indicate the default settings as being selected for a subsequent turning operation, such that the caregiver is capable of initiating the subsequent turning operation according to the default settings without re-selection of the default settings. The caregiver may be capable of modifying the default settings for the subsequent turning operation.

Before the embodiments and aspects of the disclosure are explained in detail, it is to be understood that the disclosure is not limited to the details of operation or to the details of construction and the arrangement of the components set forth in the following description or illustrated in the drawings. The disclosure may be implemented in various other embodiments and aspects and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments and aspects. Unless otherwise expressly stated, the use of enumeration should not be construed as limiting one or more embodiments or aspects to any specific order or number of components. Nor should the use of enumeration be construed as excluding from the scope of an embodiment or aspect any additional steps or components that might be combined with or into the enumerated steps or components.

### DRAWINGS

FIG. 1 shows a patient support apparatus according to one aspect of the present disclosure.

FIG. 2 shows a patient support according to one aspect of the present disclosure.

FIG. 3 shows a perspective view of a patient support according to one aspect of the present disclosure.

FIG. 4 shows a partial, exploded view of the patient support of FIG. 3.

FIG. 5 depicts a control system for a patient support according to one aspect of the present disclosure.

FIG. 6 shows a fluid control system for a patient support according to one aspect.

FIG. 7 shows a representative top view of the patient support according to one aspect.

FIG. 8 shows a user interface according to one aspect.

FIG. 9 shows a user interface according to one aspect.

FIG. 10 shows a user interface according to one aspect.

FIG. 11A shows a user interface according to one aspect.

FIG. 11B shows a user interface according to one aspect.

FIG. 12 shows a user interface according to one aspect.

FIG. 13 shows a user interface according to one aspect.

FIG. 14 shows a user interface according to one aspect.

FIG. 15 shows a user interface according to one aspect.

FIG. 16 shows a user interface according to one aspect.

FIG. 17 shows a user interface according to one aspect.

FIG. 18 shows a user interface according to one aspect.

FIG. 19 shows a user interface according to one aspect.

FIG. 20 shows a patient support for a user interface according to one aspect.

### DESCRIPTION

A patient support system is provided and includes a control system capable of directing inflation of an inflatable bladder (e.g., a turning bladder) according to a preset input (or a coarse input selection) and directing an adjustment to the inflation according to a user input, such as a fine adjustment. For instance, the control system may initiate inflation (or deflation) of the inflatable bladder toward a target inflation value (e.g., a target pressure) based on user selection of a level (e.g., a preset or a value). During inflation (or deflation), the user may select an adjustment input, such as an input to increase or decrease the target inflation value, and based on this adjustment input, the control system may increase or decrease the target inflation value and direct inflation (or deflation) of the inflatable bladder accordingly.

In one aspect, a user interface may be provided that enables a caregiver (also described interchangeably as a user) to direct operation of the control system for inflating the inflatable bladder. The user interface may provide one or more level values (e.g., preset turn levels 1, 2, 3, 4, and 5) and one or more adjustment inputs (e.g., an up arrow and a down arrow). These inputs may enable the user to select inflation of the inflatable bladder according to an initial value and then, during inflation, the user may fine tune the adjustment by adjusting the inflation up or down relative to a selected initial value. It is to be understood that the interface may enable adjustment of the initial value by inputs other than the fine tune adjustment inputs. For instance, in one aspect, the input or inputs used to select the initial value may be changed during operation to adjust the initial value. In this way, the system may be configured to allow the caregiver to provide a coarse selection or adjustment of an inflation level and a fine adjustment of the inflation level.

In one aspect, the patient support system may include first and second inflatable bladders corresponding respectively to left and right turning bladders. The user interface may include bladder selection inputs enabling selection of the left or right turning bladder for inflation according to a selected preset.

In one aspect, the user interface may include a duration selection input that enables the caregiver to select a duration over which the inflatable bladder (e.g., a left or right turning bladder) may be inflated according to a preset and/or an adjustment input.

In one aspect, the control system may be configured to store one or more previously selected operational settings, including a selected preset level, a turning duration, a selected bladder (e.g., left or right), and/or one or more adjustment values. Upon subsequent activation of the turning bladder functionality, the control system may initialize operation using the stored settings as default settings. In this way, settings selected during a prior use may be kept the same for a later use unless modified by the caregiver. By using settings selected from a prior use, the last turn settings can be reflected on the turn screen for a subsequent use. Operation may be different if the mattress has not yet been connected to the system or a new patient workflow has been set.

### I. Overview

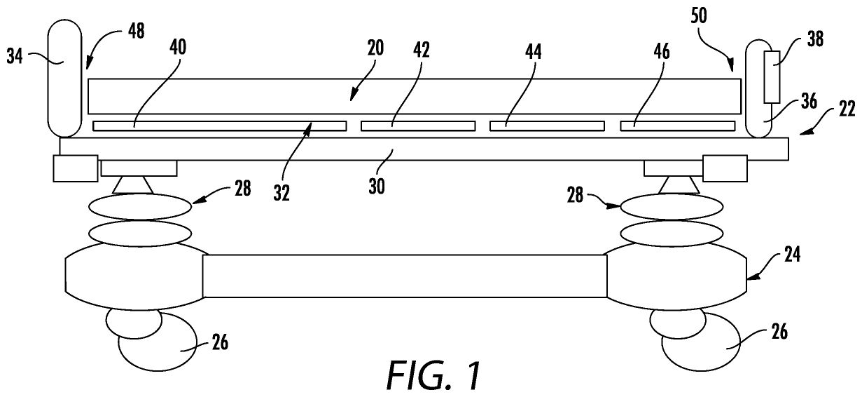

FIG. 1 illustrates a patient support 20 according to one aspect of the present disclosure. In the example of FIG. 1, the patient support 20 is a mattress. However, it will be understood that the patient support 20 may take on other manifestations, such as cushions, pads, etc. Indeed, in one aspect, the patient support 20 may be a cushion or pad for a chair, such as a wheelchair or a stationary chair. In general, the patient support 20 may be utilized wherever and whenever a patient is to be supported on a surface and it is desirable to reduce interface pressures experienced by the patient while positioned on the patient support 20.

In FIG. 1, the patient support 20 is supported on a patient support apparatus 22 that, in this particular configuration, is a bed. The patient support apparatus 22 may take on other forms besides beds, such as, but not limited to cots, stretchers, operating tables, gurneys, and the like. The patient support apparatus 22 may be a conventional support apparatus that is commercially available and that merely provides a supporting function for the patient support 20. In other aspects, the patient support apparatus 22 may include one or more controls that are integrated therein and which are used in controlling the operation of the patient support 20, as will be discussed in greater detail herein.

As shown in FIG. 1, the patient support apparatus 22 includes a base 24 having a plurality of wheels 26, a pair of elevation adjustment mechanisms 28 supported on the base 24, a frame or litter 30 supported on the elevation adjustment mechanisms 28, and a patient support deck 32 supported on the frame 30. The patient support apparatus 22 may also include a headboard 34 and a footboard 36. Either, or both, of the headboard 34 and the footboard 36 may be removable from the frame 30 and may include one or more electrical connectors for establishing electrical communication between electronic components on or in the footboard 36 and/or the headboard 34 and other electronic components supported on or in the frame 30. Such electrical connector(s) may include any one or more of the connectors disclosed in commonly assigned U.S. patent application Ser. No. 13/790,762, filed Mar. 8, 2013, by applicant Krishna Bhimavarapu and entitled PATIENT SUPPORT APPARATUS CONNECTORS, the disclosure of which is incorporated herein by reference in its entirety. Other types of connectors may also be used.

In one aspect, electrical connectors may be provided for establishing an electrical link between the patient support 20 and a user interface 38 that is positioned on, or integrated into, the footboard 36 or another aspect of the patient support apparatus 22. The user interface 38 may take on a variety of different forms, such as, but not limited to, a touch screen, a Liquid Crystal Display (LCD), a plurality of buttons, switches, knobs, or the like, or any combination of these components. The user interface 38 may allow a user to control the operation of the patient support 20. The electrical connection between the user interface 38 and the patient support 20 may take on different forms, including a direct electrical cable that runs from the footboard 36 to the patient support 20. As another example, the footboard 36 may include electrical connectors that electrically couple the user interface 38 to circuitry supported on the frame 30. This circuitry may be in further electrical communication with a port (not shown) to which an electrical cable from the patient support 20 may be inserted, thereby establishing an electrical link between the user interface 38 and the patient support 20. In yet another example, communication between the user interface 38 and the patient support 20 may be entirely wireless. A further example of such wireless communication is disclosed in commonly assigned U.S. patent application Ser. No. 13/802,992, filed Mar. 24, 2013, by applicants Michael Hayes et al. and entitled COMMUNICATION SYSTEMS FOR PATIENT SUPPORT APPARATUSES, the complete disclosure of which is hereby incorporated herein by reference.

The elevation adjustment mechanisms 28 are adapted to raise and lower the frame 30 with respect to the base 24. The elevation adjustment mechanisms 28 may be implemented as hydraulic actuators, electric actuators, or any other suitable device for raising and lowering the frame 30 with respect to the base 24. In FIG. 1, the elevation adjustment mechanisms 28 are depicted to be operable independently so that the orientation of the frame 30 with respect to the base 24 may also be adjusted. This may allow the patient support apparatus 22 to tilt a patient supported on the patient support 20 to either the Trendelenburg orientation, or the reverse Trendelenburg orientation.

The frame 30 may provide a structure for supporting the patient support deck 32, the headboard 34, and the footboard 36. The patient support deck 32 may provide a surface on which the patient support 20 can be positioned so that a patient may lie and/or sit thereon. The patient support deck 32 may be made of a plurality of sections, some of which may be pivotable about generally horizontal pivot axes—although it is to be understood that the patient support deck 32 may be configured differently without a plurality of sections (e.g., one section). In the configuration shown in FIG. 1, the patient support deck 32 includes a head or back section 40, a seat section 42, a thigh section 44, and a foot section 46. In other configurations, the patient support deck 32 may include fewer or greater numbers of sections. The head section 40, which is also sometimes referred to as a Fowler section or back section, may be pivotable between a generally horizontal orientation (shown in FIG. 1) and a plurality of raised positions (not shown in FIG. 1). The thigh section 44 and the foot section 46 may also be pivotable about horizontal pivot axes.

The general construction of any of the base 24, the elevation adjustment mechanisms 28, the frame 30, the patient support deck 32, the headboard 34, and/or the footboard 36 may take on any known or conventional design, such as, for example, that disclosed in commonly assigned, U.S. Pat. No. 7,690,059 issued to Lemire et al., and entitled HOSPITAL BED, the complete disclosure of which is incorporated herein by reference; or that disclosed in commonly assigned U.S. Pat. Publication No. 2007/0163045 filed by Becker et al. and entitled PATIENT HANDLING DEVICE INCLUDING LOCAL STATUS INDICATION, ONE-TOUCH FOWLER ANGLE ADJUSTMENT, AND POWER-ON ALARM CONFIGURATION, the complete disclosure of which is also hereby incorporated herein by reference. The construction of any of the base 24, the elevation adjustment mechanisms 28, the frame 30, the patient support deck 32, the headboard 34, and/or the footboard 36 may also take on forms different from what is disclosed in the aforementioned patent and patent publication.

In some aspects, the operation of the patient support 20 may be based at least partially upon sensor data that originates from sensors integrated into the patient support apparatus 22, while in other aspects, the patient support 20 may operate solely on sensor data originating from sensors positioned internally inside of the patient support 20. For those aspects in which the patient support 20 uses sensor data from the patient support apparatus 22, such sensor data may include angle data and/or weight data. More specifically, the patient support apparatus 22, in some aspects, may include one or more angle sensors that detect the angular orientation (with respect to horizontal) of the frame 30, as well as one or more angle sensors that detect the angular orientation (with respect to horizontal) of one or more of the sections of the support deck 32. Still further, the patient support apparatus 22, in some aspects, may include a load cell system that detects patient weight and/or a center of gravity of a patient positioned on the patient support 20. One such load cell system that may be used in patient support apparatus 22 is disclosed in commonly assigned U.S. Pat. No. 5,276,432 issued to Travis, and entitled PATIENT EXIT DETECTION MECHANISM FOR HOSPITAL BED, the complete disclosure of which is incorporated herein by reference. Other load cell systems may also be used. Regardless of the specific load cell system used, the patient support apparatus 22 may communicate any one or more of patient weight, patient center of gravity, the angular orientation of the frame 30, and/or the angular orientation of one or more of the deck sections 40, 42, 44, 46 to the patient support 20, which may use this data in manners discussed in further detail herein.

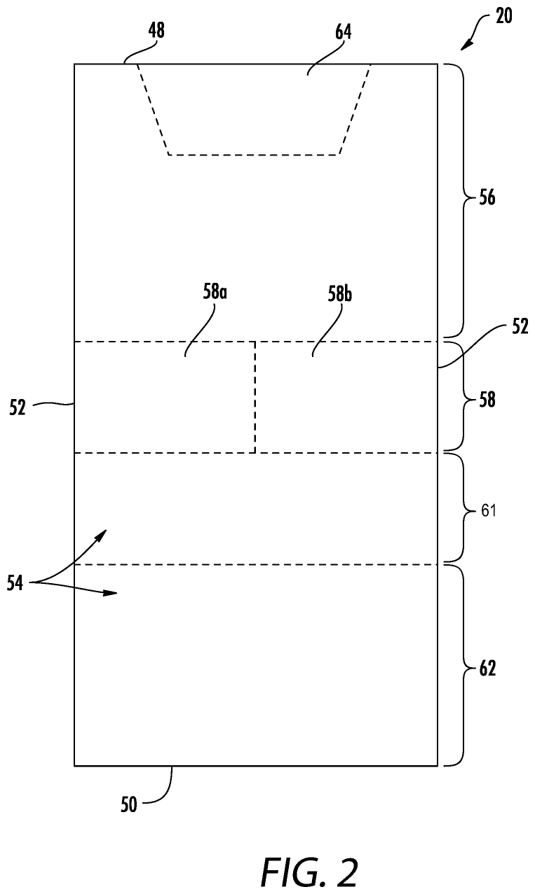

Turning to FIG. 2, the patient support 20 may further include a back zone 56, a thigh zone 61, and a foot zone 62. The back zone 56 may include a head zone or pillow zone 64. The physical boundaries of each of the zones may be modified from that shown, as well as the number of locations of each zone. In the configuration of FIG. 2, the back zone 56 is positioned such that it will generally be aligned with the head or back section 40 of the patient support apparatus 22 when the patient support 20 is positioned on the support deck 32. Similarly, the seat zone 58 will be generally aligned with the seat section 42, the thigh zone 61 will be generally aligned with the thigh section 44, and the foot zone 62 will be generally aligned with the foot section 46. Such alignment, however, is not necessary. Indeed, the patient support 20 may be used on patient support apparatuses 22 in which the support deck 32 has no individual sections, or which has a fewer or greater number than the four shown in FIG. 1.

The seat zone 58, as depicted shown in FIG. 2, is subdivided into right and left sides. That is, the seat zone 58 includes a right seat zone 58a and a left seat zone 58b. Each of the seat zones 58a and 58b define regions in which hermetically isolated bladders (also described as pods herein) may be positioned so that the inflation level corresponding to the right seat zone 58a can be controlled and/or set independently of the inflation level corresponding to the left seat zone 58b. In this manner, if a patient is lying on his or her side or is otherwise positioned closer to one side 52 than the other, zones 58a and 58b can be set, at least in some configurations, to different inflation levels. Alternatively, the inflation levels may be set for zones 58a and 58b differently in situations where the patient is positioned more toward the middle of the patient support 20. In alternative configurations, the seat zone 58 may be a single zone that does not have separate subdivisions between the right and left side, but rather is inflatable and deflatable in a unitary manner. In still other alternative configurations, one or more of the other zones 56, 60, and/or 62 may be subdivided into left and right sub-zones, or sub-divided in still other manners.

It is to be understood that the patient support 20 may be configured differently and that any of the features described in conjunction with the patient support 20 may be absent other than a control system and a user interface operable to control supply of fluid to an inflatable bladder or pod. For instance, the inflatable bladders 66 may be absent.

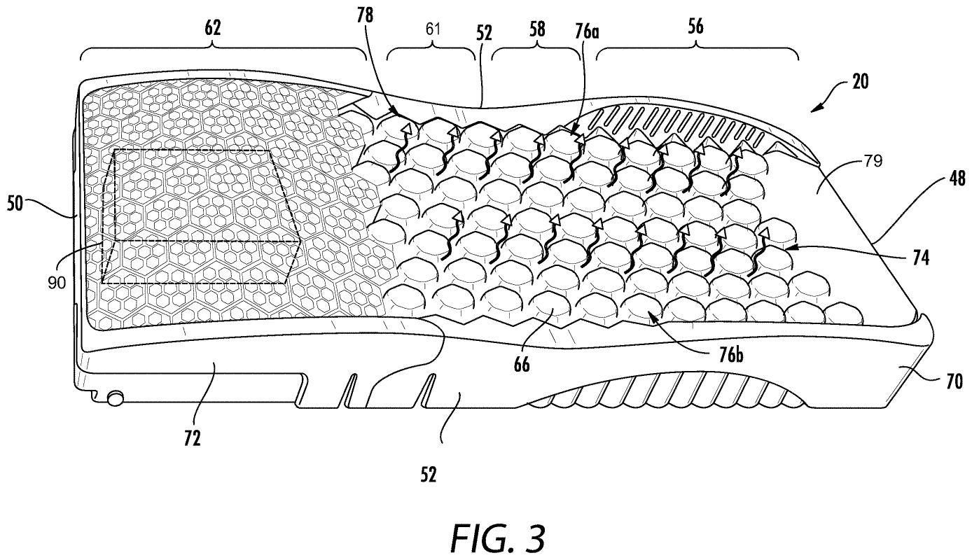

FIG. 3 shows the patient support 20 with its outer cover removed, exposing a plurality of inflatable pods 66, as well as a pillow bladder 79, a foam crib 70 that supports the pods 66, and molded foot end cushioning 72. Foam cushioning 72 is not inflatable, but instead provides cushioned support to a patient's feet through its soft pliability. In an alternative configuration, the foam crib 70 may be absent entirely or in one or more areas of the periphery of the patient support 20. In this configuration, in place of the foam crib 70, one or more inflatable pods 66 may be provided. As an example, the one or more inflatable pods 66 may be provided at the periphery in areas where the foam crib 70 is provided in the configuration depicted in FIG. 3.

In one configuration, the inflatable pods 66 are fluidly coupled together in a manner that corresponds to zones 54. For instance, all of the inflatable pods 66 within the back zone 56 may inflate and deflate together, and can be inflated and deflated separately from the inflatable pods 66 in any of the other zones. Similarly, all of the inflatable pods 66 in the right seat zone 58a, all of the inflatable pods 66 in the left seat zone 58b, as well as all of the inflatable pods 66 in the thigh zone 61, are respectively able to be inflated and deflated together, as well as separately from the inflatable pods 66 in the other zones. Thus, the inflatable pods 66 in the back zone 56 collectively define a back bladder 74, the inflatable pods 66 in the right seat zone 58a collectively define a right seat bladder 76a, the inflatable pods 66 in the left seat zone 58b collectively define a left seat bladder 76b, and the inflatable pods 66 in the thigh zone 61 collectively define a thigh zone bladder 78. It is to be understood that the bladders 74, 76a, 76b, and/or 78 can be implemented, in alternative configurations, in manners other than pods, such as, but not limited to, elongated bladders, flat bladders, can-shaped bladders, or still other shapes. As described herein, zones and/or the inflatable pods 66 may be absent from the patient support 20 (e.g., the patient support 20 may include a turning bladders without inflatable pods 66).

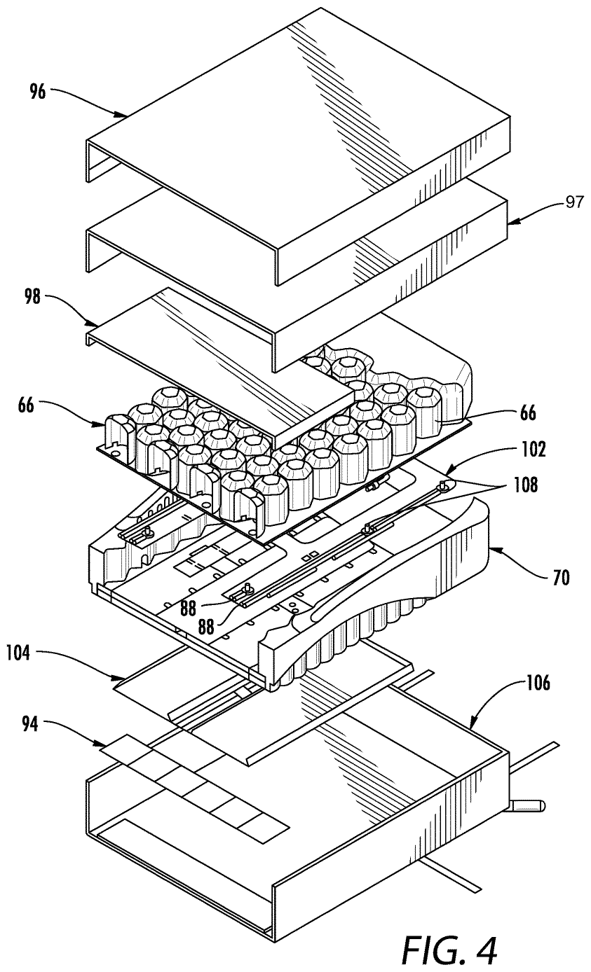

In FIG. 4, various components of the patient support 20 are shown in the back zone 56 and the seat zone 58 of FIG. 3. The patient support 20 may include one or more of the following: a top cover 96, a fire barrier layer 97, a layer of conductive fabric 98, the inflatable pods 66, a fabric manifold 102, a foam crib 70, a plurality of turning bladders 104, six depth sensors 94, one or more pressure sensors (e.g., two pressure sensors each operable to detect a pressure of fluid within respective turning bladder), and a bottom cover 106.

The top cover 96 may be made of any conventional material used in the manufacture of hospital mattresses, such as, but not limited to, a knit polyester, and/or a polyurethane. The top cover 96 in FIG. 4 is the uppermost layer of the patient support 20—although it is to be understood that the uppermost layer may be different depending on the configuration of the patient support 20. Likewise, the fire barrier layer 97 and the conductive fabric 98 may form intermediate layers between the uppermost layer and the inflatable pods 66. An additional example of an intermediate layer is a low air loss layer that is operable to receive and distribute air for microclimate control. One or more or all of the intermediate layers may be absent in alternative configurations.

The fire barrier 97 may be positioned underneath the top cover 96 (or an uppermost layer) and may be made of any suitable material that resists the spread of fire. Such materials may vary. In one configuration, the fire barrier 97 may be made of, or include, Kevlar® (poly-paraphenylene terephthalamide), or other brands of para-aramid synthetic fibers. Other materials may alternatively be used.

Examples of the depth sensors 94 and circuitry associated therewith are described in further detail in U.S. Pat. No. 11,413,202 to Lefleche et al., issued Aug. 8, 2022, assigned to Stryker Corp.—the disclosure of which is hereby incorporated by reference in its entirety. It is to be understood that depth sensors 94 may be configured differently depending on the application, and may be absent in some configurations.

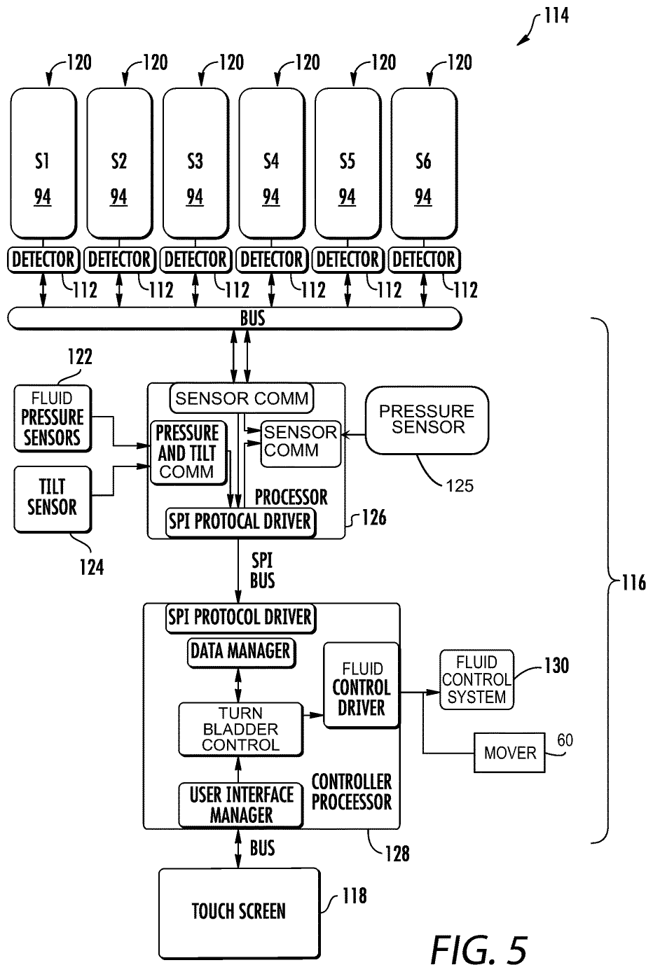

In one configuration, the top cover 96, or an intermediate layer, or a combination thereof, may include one or more sensors, such as interface sensors (depicted in FIG. 5) operable to detect an interface pressure between the patient and the patient support 20. Additionally, or alternatively, one or more sensors may be provided above the top cover 96. The interface sensors may provide sensor feedback to the pump assembly 90, which may use the sensor feedback as a basis for controlling an inflation state of the inflatable pods 66, or groups thereof.

The inflatable pods 66, as described herein, may be inflated and deflated in groups (e.g., zones 56, 58a, 58b, and 60) under the control of a pump assembly 90 depicted in FIG. 1 and its associated control circuitry. The fluid connections between the inflatable pods 66 and the pump assembly 90 may be established by a plurality of hoses 88 that run between the pump assembly 90 and various of the inflatable pods 66. The hoses 88 are housed within the fabric manifold 102. The hoses 88 each include one or more connectors 108 for fluidly connecting the hose to one or more of the inflatable pods 66.

The pump assembly 90 may be provided within an enclosure provided proximal to the foot end 50 of the patient support 20. The pump assembly 90 may be provided beneath the foot zone 62 within an enclosure. It is to be understood that the pump assembly 90 may be configured and positioned differently depending on the application, including external to the patient support 20.

The pump assembly 90, as described herein, may include a fluid mover, such as an air pump, blower, or another source of fluid (e.g., air), that may supply fluid to the hoses 88 for delivery to the inflatable pods 66 and/or the turn bladders 104. Additionally, the pump assembly 90 may be operable to remove fluid from the turn bladders 104 and/or the inflatable pods 66 via the hoses 88. In this way, with the capability to supply and remove fluid, the pump assembly 90 may selectively inflate and deflate the inflatable pods 66 in groups. In an alternative configuration, the pump assembly 90 may selectively inflate and deflate one or more of the turn bladders 104 and the inflatable pods 66, individually. As described herein, the pump assembly 90 may be operable to determine an inflation state of the turn bladders 104 and the inflatable pods 66 and/or groups thereof, and to direct a change in the inflation state based on at least one of sensor data and a directive from a caregiver provided via the user interface 38.

The turn bladders 104 may be positioned underneath the foam crib 70 and may be used to help turn a patient positioned on top of the patient support 20. To that end, the turn bladders 104 may extend generally longitudinally in a direction from the head end 48 to the foot end 50 and are each separately and independently inflatable and deflatable. The inflation of the turn bladders 104 may be controlled by the pump assembly 90 and its associated circuitry, as described herein.

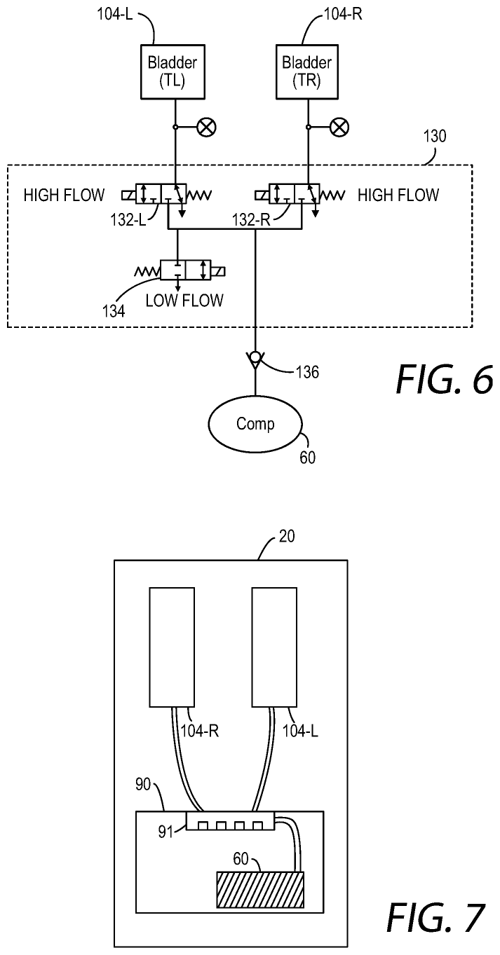

FIGS. 5 and 6 show various implementations of the patient support 20 including turn bladders 104 in conjunction with a pump assembly 90 disposed near a foot end of the patient support 20. The turn bladders 104 as described herein may be disposed on left and right sides of the patient support 20, and are labeled L and R accordingly. The pump assembly 90 may include a manifold assembly 91 capable of selectively directing fluid to one or more inflatable bladders of the patient support 20, such as the turn bladders 104. The manifold assembly 91 may be directed by the fluid control driver of the main control board 128 so that inflation (and/or deflation) of the one or more bladders can be directed according to a selected mode of operation for the patient support 20.

As described herein, and as depicted in FIG. 6, the patient support 20 may include a fluid mover in the form of a compressor 60. The compressor 60 may be directed to supply fluid to a turn bladder 104 by a fluid control system, such as a fluid control system described according to one or more aspects herein. The location of the compressor 60 may vary from application to application—e.g., the compressor 60 is disposed in the pump assembly 90 in FIG. 6. It is to be understood that the compressor 60 may be disposed anywhere with respect to the patient support 20 and/or the patient support apparatus 22, including external to one or both of the patient support 20 and the patient support apparatus 22.

### II. Control System

FIG. 5 shows one configuration of a control system 114 that may be implemented to control the patient support 20 in the manner described herein. Other types, arrangements, and/or configurations of control systems may alternatively be used. The control system 114 may include a control system 116, a user interface 118, and a plurality of sensor systems, such as one or more of the depth sensor systems 120, a tilt sensor 124, a moisture sensor with respect to the patient support surface for detecting moisture proximal to the patent, a temperature sensor for detecting temperature proximal to the patient, an air pressure sensor 122, and interface pressure sensor 125. It is to be understood that one or more of these aspects may be absent from implementation of the control system 114, such that the control system 114 may include a subset of the described aspects.

The user interface 118 may be the same as user interface 38, discussed above, which is incorporated into the footboard 36 of the patient support apparatus 22, or it may be a stand-alone user interface. Such stand-alone user interfaces may include user interfaces that are incorporated into pedestals that may be removable mounted on patient beds, such as the patient support apparatus 22. In the configuration shown in FIG. 5, the user interface 118 is a touch screen. It is to be understood that other types of user interfaces may be used, including buttons, switches, knobs, lights, and/or displays.

Each depth sensor system 120 includes one of the depth sensors 94, a corresponding detector 112, the conductive fabric 98, and, in some configurations, a shield (not shown) positioned underneath the depth sensor 94. The detector 112 may be any circuitry capable of detecting the varying capacitance between the depth sensor 94 and the conductive fabric 98. In one configuration, the detector 112 may include an AD7747 capacitance-to-digital converter manufactured by Analog Devices of Norwood, Mass. Other types of detector circuitry may be used in other aspects. Whatever the circuitry used, the detectors 112 may detect the capacitance levels between depth sensor 94 and the conductive fabric 98, which provide an indication of the vertical distance between the depth sensor 94 and the conductive fabric 98, which in turn indicates how deeply a patient is currently immersed in different areas of the seat zone 58. The number and type of the depth sensor systems 120 may vary depending on the application. In FIG. 5, there are six separate detector circuits 112, thereby generating six separate measurements of patient depth in the seat zone 58. In one configuration, depth sensor systems 120 each generate capacitive measurements multiple times a second, while in other configurations, measurements are made at different frequencies. As mentioned herein, the depth sensor systems 120 may be absent or configured differently depending on the configuration.

The control system 116 may be in electrical communication with both the user interface 118 and one or more of the sensor systems, if present, such as the depth sensor systems 120, as well as a plurality of air pressure sensors 122 and, in FIG. 5, one or more tilt sensors 124. The control system 116 in one configuration may be coupled to one or more interface pressure sensors 125, which as discussed herein may be operable to detect an interface pressure between the patient and the patient support 20. Additional sensors, such as a temperature sensor or a moisture sensor, or both may be coupled to the control system 116. Additionally, or alternatively, one or more sensors described herein may be absent from the control system 116.

The air pressure sensors 122 may measure the current air pressure inside one or more of the turn bladders 104 and the inflatable bladders 66 of the patient support 20 (e.g., back bladder 74, seat bladders 76a and 76b, thigh bladder 78, and pillow bladder 79). Each of these inflatable bladders 66 generally corresponds to zones 56, 58a, 58b, 60, and 64, respectively. It is noted that the inflatable bladders 66 may be absent in one configuration, with only the turn bladders 104 being present. In such a configuration, the air pressure sensors 122 may measure the current air pressure inside one or more of the turn bladders 104, as described but without reference to the inflatable bladders 66.

Tilt sensors 124 measure the angular orientation of one or more portions of the patient support 20, and/or they measure the entire angular orientation of the patient support 20. In some aspects, as was discussed previously, tilt sensors 124 are omitted and the patient support 20 instead receives tilt data from one or more angle sensors that are incorporated into the patient support apparatus 22. In still other aspects, the patient support 20 is implemented without any tilt sensors 124, and without receiving any tilt data from the patient support apparatus 22.

The control system 116 in FIG. 5 includes two separate circuit boards: a sensor circuit board 126 and a main control circuit board 128. The sensor circuit board 126 may receive the electrical signals from all of the various sensors and oversees the operation of these sensors (e.g., one or more of depth sensors 120, air pressure sensors 122, tilt sensors 124, interface pressure sensors 125, a temperature sensor, and a moisture sensor). The data gathered from one or more of these various sensors may be forwarded from the sensor circuit board 126 to the main control circuit board 128, and may be used as a basis for controlling supply of fluid to an inflatable bladder of the patient support 20, such as one or more of the turn bladders 104 and the inflatable bladders 66.

In one configuration, this data from the one or more sensors may be communicated via a serial peripheral interface (SPI) bus, although it is to be understood that other buses may be used for this purpose. The main circuit board 128 may be programmed, or otherwise configured, to carry out the control algorithms described herein. Generally speaking, the main circuit board 128 may determine inflation levels (e.g., a target inflation value corresponding to a target air pressure) for all or a subset of the various bladders and controls, valves, air movers, and other aspects to implement and maintain those inflation levels.

As shown in FIG. 5, each board 126 and 128 includes a processor, which may be a microprocessor or a microcontroller. Indeed, each circuit board 126 and 128 may include any electrical component, or group of electrical components, that are capable of carrying out the algorithms described herein. In many configurations, the circuit boards 126 and 128 may be microprocessor-based, although not all such configurations may utilize a microprocessor. In general, the circuit boards 126 and 128 may include any one or more microprocessors, microcontrollers, field programmable gate arrays, systems on a chip, volatile or nonvolatile memory, discrete circuitry, and/or other hardware, software, or firmware that is capable of carrying out the functions described herein. Such components may be physically configured in any suitable manner, such as by mounting them to one or more circuit boards, or arranging them in other manners, whether combined into a single unit or distributed across multiple units. It is to be further understood that the control system 116 may be implemented in different forms from the two boards 126 and 128 illustrated in FIG. 5. Such variations may include combining the functions of both boards 126 and 128 onto a single board, or further distributing the functions of these boards onto more than the two boards 126 and 128 shown in FIG. 5.

### III. Fluid Control System and Fluid Mover

In FIG. 5, the control system 114 includes a fluid control system 130 (e.g., an air control system) operably coupled to the main circuit board 128. The main circuit board 128 may include a fluid control driver configured to direct operation of the fluid control system 130 based on directives from a pressure vessel control system implemented by the main control board 128—although control over the fluid control system 130 may be implemented differently. For instance, the fluid control system 130, itself, may include a control system operable to control aspects of the fluid control system 130 independently of the main circuit board 128 and/or based on directives from the main circuit board 128 or another component of the patient support 20.

In one aspect, by way of electrical signals sent to the fluid control system 130, the main control board 128 may be able to implement suitable inflation levels of the various bladders. The fluid control system 130 may be operable to exhaust air from one or more of the turn bladders 104 and the inflatable bladders 66, or groups thereof, to the atmosphere and/or to an air mover of the air control system 130.

The fluid control system 130 may be operably coupled to a fluid movers 60 to control supply to and/or from one or more inflatable bladders 66 and/or turn bladders 104.

One or more aspects of the fluid control system 130 and/or the fluid mover 60 may be incorporated into the pump assembly 90. For instance, as described, the fluid control system 130 may include a plurality of fluid valves operably coupled to the fluid mover 60—these components or a subset thereof may be provided in the pump assembly 90 proximal to the foot end 50 of the patient support 20. Optionally, one or more components of the fluid control system 130 and the fluid mover 60 may be external to the pump assembly 90, and further optionally one or more of such components may be external to the patient support 20.

A fluid control system 130 according to one aspect is shown in FIG. 6 and includes a first valve 132-L and a second valve 132-R associated respectively with left and right turn bladders 104-L, 104-R. The first and second valves 132-L, 132-R may selectively direct fluid from the fluid mover 60 respectively to the left and right turn bladders 104-L, 104-R. It is to be understood that the number and type of valves may vary from application to application, and that the present disclosure is not limited to supplying fluid to turn bladders 104. For instance, for purposes of disclosure, several aspects are described herein in conjunction with supplying fluid to turn bladders 104; however, any inflatable bladder may be used in place of the turn bladders 104 described in conjunction with these aspects, such that fluid may be supplied to any inflatable bladder according to one or more aspects described herein.

The fluid control system 130 in one aspect may include an exhaust valve 134 selectable to facilitate slowly deflating a bladder 104-L, 104R in contrast to quickly dumping fluid from a bladder 104-L, 104R to the atmosphere. This way, a pressure in the bladder 104-L, 104R can be reduced in a more controlled manner relative to exhausting the fluid to the atmosphere quickly. Additionally, the fluid control system 130 may include a check valve 136 operable to prevent back flow of fluid toward the fluid mover 60.

The fluid mover 60 is described as a compressor in some configuration, but the present disclosure is not limited to this configuration. The fluid mover 60 may be any type of component or components capable of supplying fluid. For instance, the fluid mover 60 may be a compressor or blower operable alone or in conjunction with a fluid reservoir or tank capable of storing fluid received. Examples of such a configuration are described in further detail in U.S. Provisional Ser. No. 63/739,788, filed Dec. 30, 2024, by applicants Matthew T. Thielking et al., and entitled PRESSURE VESSEL AND CONTROL THEREOF FOR A SUPPORT SURFACE—the disclosure of which is incorporated by reference herein in its entirety.

In FIG. 6, the fluid mover 60 corresponds to a compressor that may supply fluid, such as air, to a turning bladder 104.

The main control board 128 may direct one or both of the valves 132-L, 132-R to selectively open and provide a fluid path from the fluid mover 60 to one or both of the turn bladders 104-L, 104-R so that the fluid mover 60 is operable to supply fluid as an air mover to one or both of the turn bladders 104-L, 104-R.

The valves 104-L, 104-R of the fluid control system 130 may vary from application to application. In FIG. 6, the valves 104-L, 104-R correspond to pneumatic valves in a 3/2 configuration with an integrated exhaust port. It is to be understood that the valve configuration and type may be different.

In operation, the main control board 128 may direct the control system 130 to supply fluid from the fluid mover 60 to one or both of the turn bladders 104-L, 104-R, as described herein.

### IV. User Interface

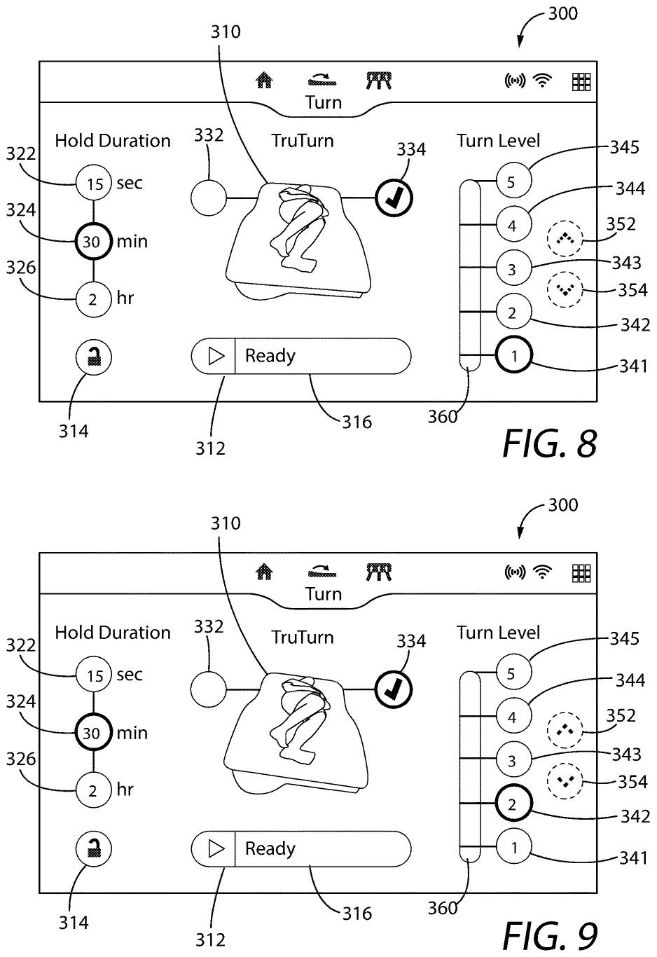

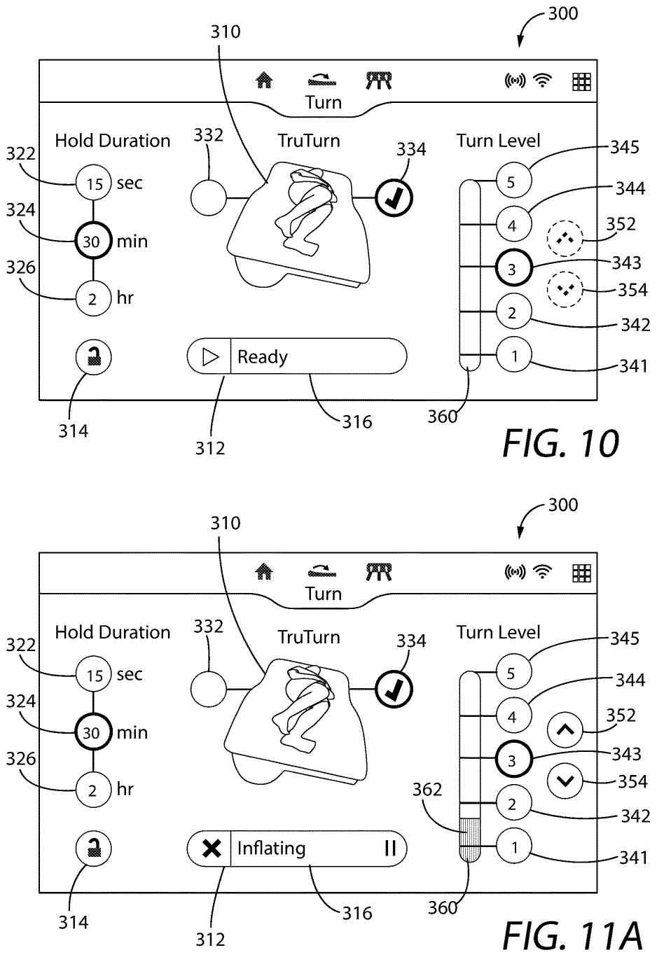

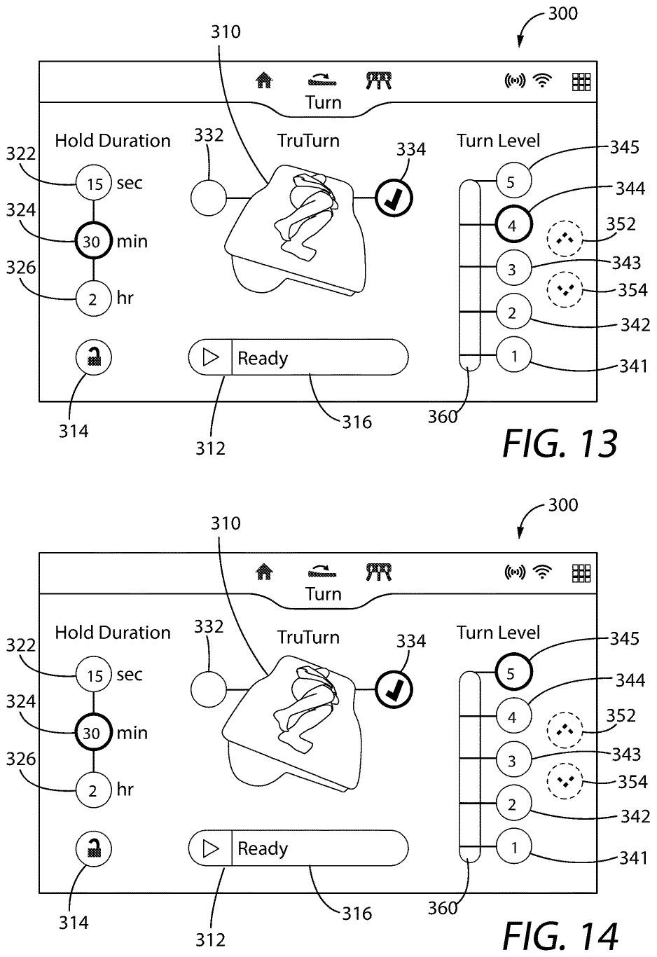

A turning bladder interface according to one aspect is shown in FIGS. 8-14 and 19 and generally designated 300. The turning bladder interface 300 may correspond to a menu or page displayable by the user interface 38 and provides various user inputs for selection by a caregiver to control operation of the patient support apparatus 22, including the fluid control system 130 and the turning bladders 104-L, 104-R according to a selected mode of operation. The turning bladder interface 300 may communicate user selections to the control system 114.

The turning bladder interface 300 is shown with a variety of modes for enabling control over a level of a turning bladder 104, including turning duration, levels (e.g., pressure levels), and bladder selection (e.g., left bladder 104-L or right bladder 104-R). Additional and/or fewer modes may be provided, including turning frequency and angle settings. Various modes of operation may be selected via a variety of user inputs, each of which, when selected, may change the state as displayed on the turning bladder interface 300 to indicate the selected mode.

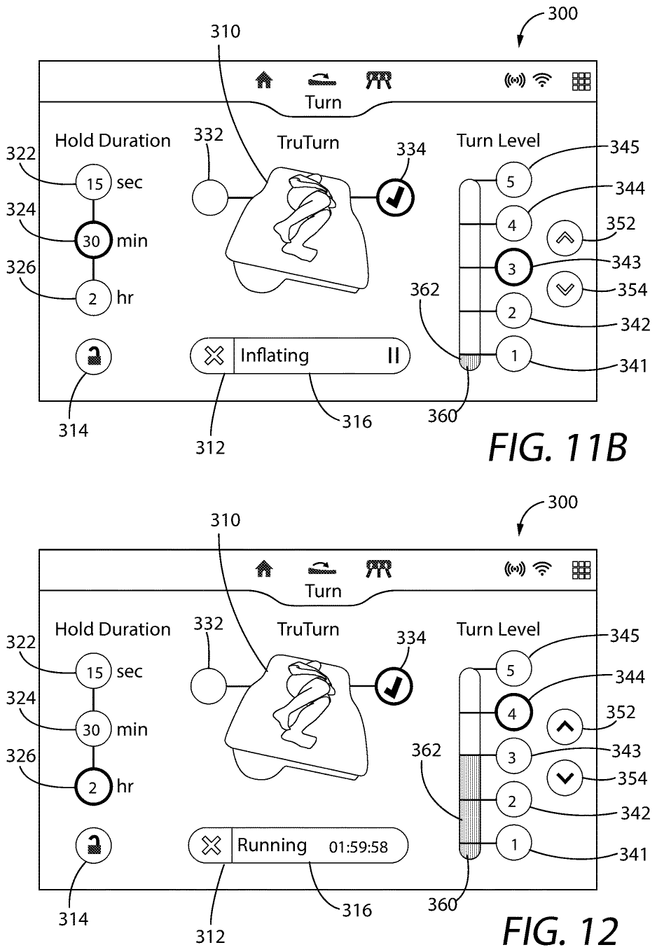

The turning bladder interface 300 may provide one or more turning duration inputs 322, 324, 326, which may vary in number and vary in duration depending on the application. In FIGS. 8-14, the turn duration inputs 322, 324, 326 may correspond to 15 s, 30 min, and 2 hr options. Additional or fewer turn duration inputs may be provided—e.g., four inputs may be provided as 15 s, 30 min, 2 hr, and 3 hr options. As depicted in FIGS. 8-14, the turning duration input 326 is shown selected for a 30 min duration. This duration may correspond to a hold duration so that the selected duration may be held for a time period that begins after a selected turning bladder 104 has been inflated to a selected level (or above a threshold level that may be less than the selected level). For instance, in FIGS. 11A, 11B, and 12, a progress indicator 316 is shown transitioning from an inflating status in FIG. 11A that is less than 1, to an inflating status in FIG. 11B that is greater than 1, and then to a running status indicative of the remaining time on the selected duration in FIG. 12. The transition can be seen to occur after a level status 362 of a level indicator 360 reaches the selected level 343.

In one aspect, during inflation toward the selected preset level, the caregiver may provide an input (e.g., via an input provided by the progress indicator 316 or the start input 312) to pause inflation at a current level, which may be different from a selected level 343. For instance, the pause symbol shown in the progress indicator 316 in FIG. 11A may be selected by the user to pause inflation at a current level, optionally setting the target inflation level at the current level and starting the hold timer to hold the current level for the selected turning duration. In this way, inflation toward a prior preset target may be ceased and the selected turning bladder 104 can be maintained at the current inflation value for a hold duration, which may correspond to a selected turning duration (e.g., 15 seconds, 30 minutes, 2 hours, or another duration).

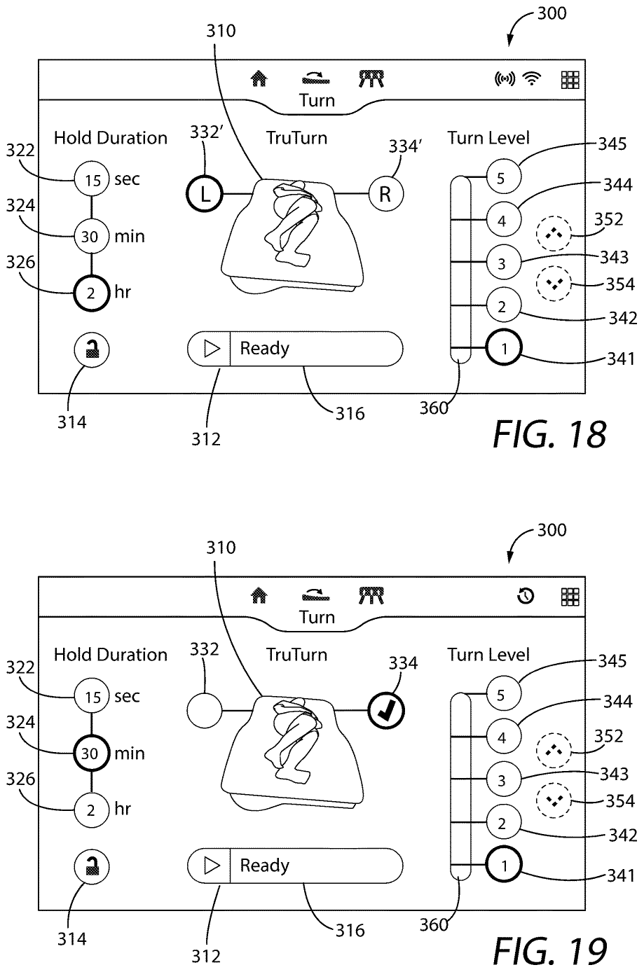

The turning bladder interface 300 may provide bladder selection inputs 332, 334 corresponding to each of the available turning bladders 104 capable of being controlled for a turning operation. For instance, in FIG. 8, the left turn bladder 104-L is shown selected via the bladder selection input 332. The control system 114 may direct operation of a selection valve 132-L, 132-R based on the user's selection of a bladder selection input 332, 334 (along with input requesting initiation of a turn operation e.g., via selection of a start input 312). The selection inputs 332, 334 are shown in FIGS. 8-14 as checkmarks, but these inputs may be replaced with another type of indicator, such as the “L” and “R” designations respectively for the alternative bladder selection inputs 332', 334′ indicators in FIG. 18.

In operation, as described herein, inflation of the selected turning bladder 104 can facilitate a turn operation for the patient. A turn of the patient may involve rotation of the patient of the patient—e.g., a left turn as selected and shown in FIG. 12 involves inflation of the left turn bladder 104-L to cause clockwise rotation of the patient (from the patient's perspective). Likewise, a right turn via selection of the right turn bladder 104-R may cause counter-clockwise rotation of the patient (from the patient's perspective). The left and right turn bladders 104-L, 104-R correspond to left and right turning operations for the patient, meaning the left turn bladder 104-L may be inflated to carry out a left turn operation and the right turn bladder 104-R may be inflated to carry out a right turn operation. Because a left turn operation is carried out by clockwise operation, and because such a turn operation is conducted by raising the right side of the patient, the left turn bladder 104-L may be disposed on the right side of the patient support 20. Conversely, for similar reasons, the right turn bladder 104-R may be disposed on the left side of the patient support 20.

The turning bladder interface 300 may provide a preset level inputs 341, 342, 343, 344, 345 as described herein. The number and available levels associated with the preset level inputs 341, 342, 343, 344, 345 may vary from application to application. As described herein, the caregiver may select one of the preset level inputs 341, 342, 343, 344, 345, and the control system 114 may direct inflation of a turning bladder 104-L, 104-R according to the selection thereof via the turning bladder interface 300. Inflation may be directed by identifying a target inflation value based on the selected preset level input 341, 342, 343, 344, 345. The target inflation value may or may not be greater than a current inflation value of a selected bladder 104, and the control system 114 may direct inflation or deflation of the selected bladder accordingly. The preset level inputs 341, 342, 343, 344, 345 may be selected after inflation for a turning operation has already been initiated, enabling a coarse adjustment relative to a current target inflation value.

The current inflation value of a selected bladder 104 may be based on sensor input obtained from a fluid pressure sensor 122 associated with the selected bladder 104. The control system 114 may utilize a feedback-based control loop (e.g., P, PI or PID control loops) to control supply of fluid via operation of the fluid mover 60 to the selected bladder 104, where the feedback-based loop may be based on a current inflation value relative to a target inflation value.

The turning bladder interface 300 may include a level indicator 360 capable of providing an indication of a current inflation value associated with a selected bladder 104. For instance, in FIGS. 11 and 12, the level status 362 indicates a current inflation value for a selected bladder relative to the available levels associated with the preset level inputs 341, 342, 343, 344, 345. As the inflation pressure of a selected bladder increases, the sensed pressure of the selected bladder 104 may increase, and the depicted level status 362 may increase for the selected bladder 104.

The turning bladder interface 300 may provide a first adjustment input 352 and a second adjustment input 354. These adjustment inputs may enable a caregiver to selectively increase or decrease a target inflation value during operation. For instance, the first adjustment input 352 may correspond to an upward adjustment input, and the second adjustment input 354 may correspond to a downward adjustment input. In use, the caregiver may select the first adjustment input 352 in order to increase a target inflation value relative to the current target inflation value, which may correspond to the selected preset if no adjustments have been requested previously. Alternatively, the caregiver may select the second adjustment input in order to decrease the target inflation value relative to the current target inflation value. With this approach, the caregiver can decide to increase or decrease a level for a turning operation in use after the turning operation has been initiated, and provide a directive to the control system 114 via the first and second adjustment inputs 352, 354.

As depicted in FIGS. 8-10, 13, 14, and 17-19, the first and second adjustment inputs 352, 354 are shown disabled (e.g., in dash lines), because a turning operation has not yet been initiated. After a turning operation has been initiated, as depicted for example in FIG. 11A, the first and second adjustment inputs 352, 354 are enabled for user selection.

In FIGS. 8-14, the turn bladder interface 300 includes a bed graphic 310 that provides a representative depiction of the patient support 20. The bed graphic 310 may be dynamic, showing changes in the patient support 20 based on selected modes of operation. For instance, in FIGS. 8-14, the bed graphic 310 is depicted with a left turn bladder (which is selected to be opposite the selected side via the selection input 332, which may be used to select the side toward which the patient is to be turned and is opposite the turn bladder to be inflated) being inflated to facilitate turning a patient disposed on a bed. The level of depicted inflation may change based on the selected turn level (e.g., 1, 2, 3, 4, 5, with 5 being the highest level and 1 being the lowest level). Selection of a turn level may cause the bed graphic 310 to change (e.g., animation) to depict a turn level for the selected turn bladder.

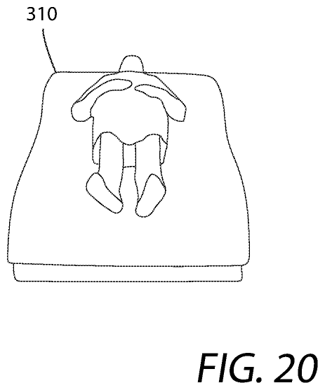

In one aspect, the bed graphic 310 may include a graphical representation of a patient disposed on the patient support 20. During or after inflation of a selected turning bladder, the graphical representation of the patient may depict the patient lifted or rotated relative to the patient support 20 so that at least a portion of the graphical representation of the patient appears visually separated from, or not rigidly connected to, the surface of the patient support 20. Such a graphical depiction of a portion of the patient (e.g., a portion the patient's posterior) is separated visually from the patient support 20 can be seen in FIG. 12, in contrast to the patient being shown flat on surface of a bed graphic 310 in FIG. 20 (e.g., the patient is lying flat on his or her back and is shown with their posterior surface visually coupled to the surface).

Optionally, the graphical representation of the patient may be depicted as movable relative to the patient support 20, such that the patient graphic shifts position independently of the graphic of the patient support 20 during or after a turning operation, thereby visually conveying that the patient is not rigidly fixed to the mattress during the turn. In an unturned configuration, the graphical representation of the patient may be depicted as lying flat on the patient support, and during or after a turning operation, the patient graphic may animate or vary to depict at least a portion of the patient being visually separated from the surface of the patient support 20. This way, the graphical representation may visually distinguish between an unturned configuration in which the patient is flat on the patient support 20 and a turned configuration in which the patient is elevated or angled relative to the surface of the patient support 20.

The turn bladder interface 300 includes a variety of additional user inputs, including a lock input 314 capable of being selected to lock the turn bladder interface 300. The lock input 314 may also be selected to lock the user input screen, as well as to unlocks this same screen. The locking input may be a 2-sec press and hold.

In one aspect, the turning bladder interface 300 may visually indicate that previously selected settings are active (e.g., selected) as default settings when the interface is displayed. The caregiver may modify the default settings via the preset level inputs, duration inputs, or adjustment inputs. Such modifications may correspond to changes selected by the caregiver prior to initiating a turning operation and stored as new defaults for a subsequent turning operation.

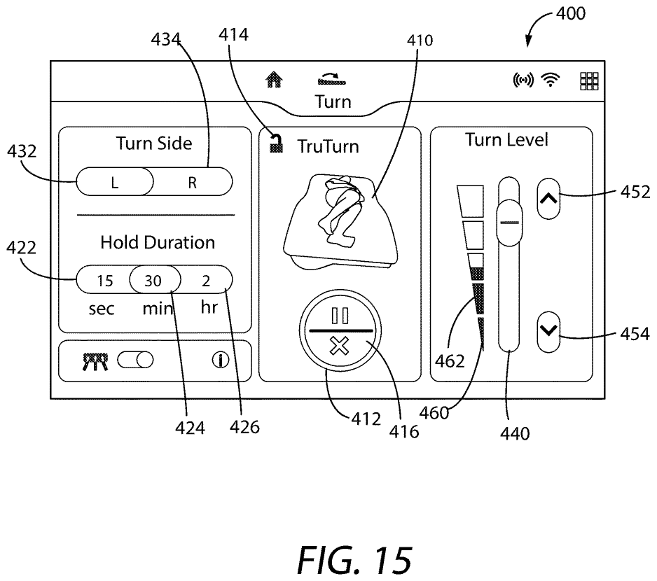

A turn bladder interface 400 according to another aspect is shown in FIGS. 15-17. The turn bladder interface 400 provides a number of user inputs similar to those of the turning bladder interface 300 and may correspond to a menu or page displayable by the user interface 38 and provides various user inputs for selection by a caregiver to control operation of the patient support apparatus 22, including the fluid control system 130 and the turning bladders 104-L, 104-R according to a selected mode of operation. The turning bladder interface 400 may communicate user selections to the control system 114.

Like the turning bladder interface 300, the turning bladder interface 400 is shown with a variety of modes for enabling control over a level of a turning bladder 104, including turning duration, levels (e.g., pressure levels), and bladder selection (e.g., left bladder 104-L or right bladder 104-R). Additional and/or fewer modes may be provided, including turning frequency and angle settings. Various modes of operation may be selected via a variety of user inputs, each of which, when selected, may change state as displayed on the turning bladder interface 300 to indicate the selected mode.

The turning bladder interface 400 may provide one or more turning duration inputs 422, 424, 426, which may vary in number and vary in duration depending on the application, similar to the one or more turning duration inputs 322, 324, 326 but configured for selection in a different manner. Likewise, the turning bladder interface 400 may also provide bladder selection inputs 432, 434 similar to the bladder selection inputs 332, 334 and corresponding to each of the available turning bladders 104 capable of being controlled for a turning operation.

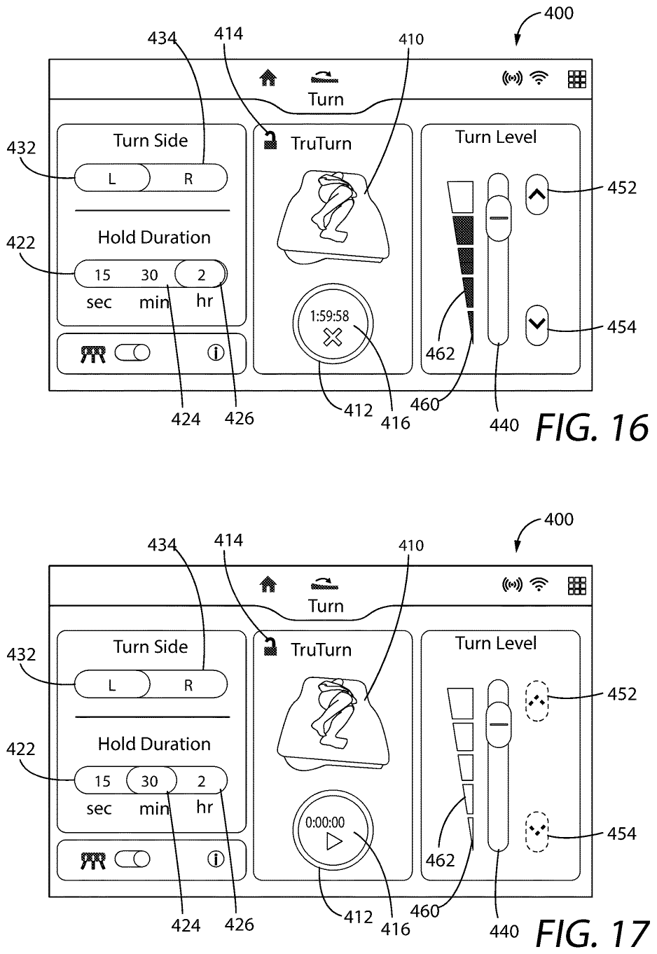

A progress indicator 416 and a start input 412 may be provided by the turning bladder interface 400, similar to the progress indicator 316 and the start input 312 described in conjunction with the turn bladder interface 300. For instance, in FIG. 16, the progress indicator 416 is indicative of a hold timer running for about 2 hours, for which the system may maintain the level of the selected turning bladder at the level indicated by the level indicator 460. The start input 412 in this configuration also provides a graphic element (“X”) that the caregiver can select to discontinue a turning operation. Additionally, a lock input 414 may be provided similar to the lock input 314 with similar operational functionality.

The turning bladder interface 400 may include a level indicator 460 capable of providing a level status 462 with an indication of a current inflation value associated with a selected bladder 104, similar to the level indicator 360. Additionally, in FIG. 15, the turn bladder interface 400 includes a bed graphic 410 similar to the bed graphic 310 that provides a representative depiction of the patient support 20. Optionally, the bed graphic 410 may be dynamic similar to the bed graphic 310.

The turning bladder interface 400 may provide a value level input 440 that enables a user to select an initial level or allow a coarse adjustment to a current level. For instance, the value level input 440 may take the form of a slider that can be manipulated upward and downward in a coarse manner, which the control system 114 may translate into a target inflation value for a selected turn bladder 104 and/or adjustments in the target inflation value. A first adjustment input 452 and a second adjustment input 454 may be provided, similar to the first adjustment input 352 and a second adjustment input 354, to enable the caregiver to increase or decrease the target inflation value relative to the current target inflation value input by the user via the value level input 440.

Directional terms, such as “vertical,” “horizontal,” “top,” “bottom,” “upper,” “lower,” “inner,” “inwardly,” “outer” and “outwardly,” are used to assist in describing embodiments and aspects of the present disclosure based on the orientation of the embodiments and aspects shown in the illustrations. The use of directional terms should not be interpreted to limit embodiments or aspects to any specific orientation(s).

The above description is that of current embodiments and aspects of the disclosure. Various alterations and changes can be made without departing from the spirit and broader aspects of the disclosure as defined in the appended claims, which are to be interpreted in accordance with the principles of patent law including the doctrine of equivalents. This disclosure is presented for illustrative purposes and should not be interpreted as an exhaustive description of all embodiments or aspects of the disclosure or to limit the scope of the claims to the specific elements illustrated or described in connection with these embodiments or aspects. For example, and without limitation, any individual element(s) of the described embodiments or aspects may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments and aspects include a plurality of features that are described in concert and that might cooperatively provide a collection of benefits. The present disclosure is not limited to only those embodiments or aspects that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, and any combination of X, Y and Z, for example, X, Y, Z; X, Y; X, Z; and Y, Z.

While several forms have been shown and described, other changes and modifications will be appreciated by those skilled in the relevant art. Therefore, it will be understood that the embodiments shown in the drawings and described above are merely for illustrative purposes, and are not intended to limit the scope of the disclosure which is defined by the claims which follow as interpreted under the principles of patent law including the doctrine of equivalents.

1. A patient support system for a patient support apparatus including a deck with one or more deck sections, the patient support system comprising:
a patient support being supported on the deck;
an inflatable bladder operable to facilitate turning a patient disposed on the patient support;
a fluid source operable to supply fluid under pressure to the inflatable bladder; and
a control system configured to direct inflation of the inflatable bladder, the control system operable to deflate the inflatable bladder, the control system operable to direct inflation of the inflatable bladder toward a target inflation value according to one of a plurality of presets, the control system, while directing inflation toward the target inflation value, operable to direct an adjustment in the target inflation value of the inflatable bladder based on input from a caregiver.

2. The patient support system of claim 1, wherein, in response to the input from the caregiver, the control system adjusts the target inflation value to a current inflation value of the inflatable bladder so that the control system ceases inflating the inflatable bladder toward a prior target inflation value associated with the one or more presets.

3. The patient support system of claim 2, wherein, in response to the input from the caregiver, the control system is operable to pause inflation, and wherein a hold timer starts so that the inflatable bladder is scheduled to remain at the current inflation value for a duration corresponding to a hold time.

4. The patient support system of claim 1, wherein in response to user selection of a new preset other than an initially selected preset of the one or more presets and before a current inflation value of the inflatable bladder reaches the target inflation value, the control system adjusts the target inflation value to correspond to the new preset, wherein, if the new preset is below the initially selected preset, the control system deflates the inflatable bladder by exhausting fluid until the current inflation value corresponds to the target inflation value associated with the new preset, and wherein, after the current inflation value corresponds to the target inflation value, the control system initiates a hold timer for a duration corresponding to a hold duration input to the control system.

5. (canceled)

6. The patient support system of claim 1, wherein the adjustment in the target inflation value of the inflatable bladder is initiated during inflation of the inflatable bladder according to the one or more presets.

7. The patient support system of claim 1, comprising a user interface operable to receive user input from the caregiver, the user interface communicatively coupled to the control system and operably provide the user input to the control system.

8. (canceled)

9. The patient support system of claim 1, wherein the user interface includes a graphical representation of a patient disposed on the patient support, and wherein, when the inflatable bladder is inflated, the graphical representation of the patient shows at least a portion of the patient visually separated from a surface of the patient support.

10. The patient support system of claim 7, wherein the user interface includes one or more preset inputs corresponding respectively to the one or more presets, and wherein the user interface includes a first adjustment input respectively corresponding to the input on which the adjustment in the target inflation value of the inflatable bladder is based, wherein the first adjustment input corresponds to an upward adjustment input that directs the control system to increase the target inflation value relative to a current target inflation value, wherein the user interface includes a second adjustment input that directs the control system to decrease the target inflation value relative to the current target inflation value.

11. (canceled)

12. (canceled)

13. (canceled)

14. (canceled)

15. (canceled)

16. (canceled)

17. (canceled)

18. The patient support system of claim 1, comprising a sensor system operable to generate sensor output indicative of a fluid pressure of the inflatable bladder, wherein a current inflation value of the inflatable bladder is based on the sensor output.

19. The patient support system of claim 1, wherein the control system is configured to store the target inflation value corresponding to the selected preset, a selected duration, and a selected bladder as default settings, and wherein the user interface indicates the default settings as being selected for a subsequent turning operation, such that the caregiver is capable of initiating the subsequent turning operation according to the default settings without re-selection of the default settings.

20. The patient support system of claim 19, wherein the caregiver is capable of modifying the default settings for the subsequent turning operation.

21. A patient support system for a patient support apparatus including a deck with one or more deck sections, a patient support being supported on the deck, the patient support system comprising:
a pressure sensor interface operable to receive sensor information indicative of a fluid pressure of an inflatable bladder associated with the patient support;
a fluid control interface operably coupled to a fluid mover and configured to direct the fluid mover to supply fluid under pressure to the inflatable bladder;
a user interface operable to receive a first user input from a caregiver corresponding to a selected level from among a plurality of levels, the user interface operable to receive a second user input from the caregiver corresponding to an adjustment in inflation of the inflatable bladder; and
a controller operably coupled to the pressure sensor interface and the fluid control interface, the controller configured to determine a target inflation value based on the selected level from among the plurality of levels, the controller configured to direct operation of the fluid mover, via the fluid control interface, to change an inflation level of the inflatable bladder based on the target inflation value and a current inflation value, the controller configured to direct the adjustment in the target inflation value based on the second user input from the caregiver, wherein the current inflation value is based on the sensor information.

22. The patient support system of claim 21, wherein, in response to the second user input from the caregiver, the controller adjusts the target inflation value to the current inflation value of the inflatable bladder so that the controller ceases inflating the inflatable bladder toward a prior target inflation value associated with the plurality of levels.

23. The patient support system of claim 22, wherein, in response to the second user input from the caregiver, the control system pauses inflation, and wherein a hold timer starts so that the inflatable bladder is scheduled to remain at the current inflation value for a duration corresponding to the hold time.

24. The patient support system of claim 21, wherein in response to user selection of a new level other than an initially selected level of the plurality of levels and before a current inflation value of the inflatable bladder reaches the target inflation value, the control system adjusts the target inflation value to correspond to the new level, wherein, if the new level is below the initially selected level, the control system deflates the inflatable bladder by exhausting fluid until the current inflation value corresponds to the target inflation value associated with the new level, and wherein, after the current inflation value corresponds to the target inflation value, the control system initiates a hold timer for a duration corresponding to a hold duration input to the control system.

25. (canceled)

26. The patient support system of claim 21, wherein the adjustment in the target inflation value of the inflatable bladder is initiated during inflation of the inflatable bladder according to the one or more levels.

27. The patient support system of claim 21, wherein the user interface includes one or more preset inputs corresponding respectively to the one or more levels, wherein the second user input corresponds to an upward adjustment input that directs the controller to increase the target inflation value relative to a current target inflation value, wherein the user interface includes a second adjustment input that directs the controller to decrease the target inflation value relative to the current target inflation value.

28. (canceled)

29. (canceled)

30. The patient support system of claim 21, wherein the user interface includes a status indicator that provides an indication of the current inflation value of the inflatable bladder.

31. (canceled)

32. (canceled)

33. The patient support system of claim 21, wherein the user interface includes a graphical representation of a patient disposed on the patient support, and wherein, when the inflatable bladder is inflated, the graphical representation of the patient shows at least a portion of the patient visually separated from a surface of the patient support.

34. The patient support system of claim 21, wherein the controller is configured to store the target inflation value corresponding to the selected level, a selected duration, and a selected bladder as default settings, wherein the user interface indicates the default settings as being selected for a subsequent turning operation, such that the caregiver is capable of initiating the subsequent turning operation according to the default settings without re-selection of the default settings, and wherein the caregiver is capable of modifying the default settings for the subsequent turning operation.
